(19) United States
(12) Patent Application Publication
(10) Pub. No.: US 2002/0156403 A1
(43) Pub. Date: Oct. 24, 2002

(54) APPARATUS AND METHOD FOR TREATMENT OF XEROSTOMIA

(76) Inventors: STEPHEN M. MEGINNISS III, SEATTLE, WA (US); KEVIN T. UNDERWOOD, ISSAQUAH, WA (US)

Correspondence Address: CLARK A PUNTIGAM, JENSEN & PUNTIGAM P S, 1020 UNITED AIRLINES BLDG, 2033 SIXTH AVENUE, SEATTLE, WA, 981212584

(21) Appl. No.: 09/316,990

(22) Filed: May 24, 1999

(51) Int. Cl. A61H 7/00

(52) U.S. Cl. 601/46; 601/72; 601/137

(57) ABSTRACT

A vibrating driver assembly is used to vibrate a mounting means, on which a stimulator member is positioned. The stimulator member is a flexible rubber (elastomeric) member which is positioned in operation so as to contact tissue within the vicinity of a salivary gland or a salivary duct of the human body or the salivary gland/duct directly. The vibration of the stimulator member has such a frequency and amplitude and the stimulator itself has such a configuration and arrangement as to result in a vibration of the salivary gland or salivary duct sufficiently and of such a character to produce a significant increase in the production of saliva and/or movement of the saliva from the salivary gland into the mouth.

### TECHNICAL FIELD

This invention relates generally to treatment for xerostomia (dry mouth) and more particularly concerns an apparatus and method for such treatment involving stimulation of the salivary glands and/or salivary ducts.

### BACKGROUND OF THE INVENTION

Xerostomia or salivary hypofunction refers to a condition generally known as “dry mouth”. Over 60 million Americans reportedly suffer from some level of dry mouth. Generally, xerostomia is characterized by a significant decrease in, or in some cases a complete lack of, saliva secretion and flow thereof into the oral cavity. While there is objectively a loss of saliva, the condition is also typically accompanied by significant, although more subjective, feelings of oral dryness. Clinically the condition is described as a dramatic reduction in the secretion of unstimulated saliva.

Although there is certainly variation between individuals, the average unstimulated saliva flow rate in humans is around 0.3 milliliters per minute. Stimulated flow rate is approximately 1.5-2.0 milliliters per minute. At the unstimulated value, there is no feeling of dry mouth. If this value drops, however, by 50%, oral dryness becomes noticeable in most people. Besides the discomfort of dry mouth, xerostomia has a number of severe undesirable consequences. Typically, there is an elevated incidence and severity of oral dental and periodontal disease, usually as a result of increased levels of bacteria in the oral cavity, due to lack of antibacterial agents and properties present in normal saliva.

Even particular dental surfaces that are not commonly affected by dental disease and caries may be involved, i.e. the cuspids and cervical region. The pH and buffering capacity of the saliva are also decreased with xerostomia, and deterioration of oral soft tissues often occurs. Oral microbial ecology is also affected, with the normal concentrations of lactobacilli and yeast (candidiasis) typically being elevated.

Additional symptoms of xerostomia may be present, which can range from mildly annoying to those which are painful and even debilitating. The lips may be dry or cracked. Further, the patient may experience a burning sensation on the tongue or other pain in the tongue. The major salivary glands also may be distended and painful to the touch if the salivary ducts are blocked. Patients typically indicate that they must constantly drink fluids and often further report difficulty in eating dry foodstuffs and/or difficulty in wearing complete dentures. Swallowing, speech and taste perception are also affected to different degrees.

Xerostomia may be caused by medical conditions, medical treatment, or may be a side effect of one or a combination of literally hundreds of different medications. Xerostomia may also be a natural result of the aging process. Elderly individuals are commonly affected. While drug-induced xerostomia is typically reversible by changing medications, many medications cannot be changed due to similar side effects or lack of therapeutic value. Medical condition-based xerostomia currently must be either tolerated or treated in some manner.

Previous treatments for xerostomia have been directed at the relief or reduction of symptoms. If xerostomia is drug-induced, for instance, a physician may alter the medication regimen. However, if xerostomia has a disease base, or if the medication cannot be changed, then for those patients who have some residual salivary gland capability, chewing gum or biochemical or pharmaceutical means or electronic devices may provide some relief. Those patients who do not respond to such treatments must rely on artificial saliva substitutes, which are taken orally to relieve the symptoms.

### SUMMARY OF THE INVENTION

Accordingly, the present invention is an article and method for use in the treatment of xerostomia, comprising: a driver assembly which is capable of producing a vibrating action at a drive frequency; and a stimulator assembly operatively connected to said driver assembly such that the stimulator assembly vibrates in response to operation of the driver assembly, the stimulator assembly including a stimulator member for vibrating a salivary member, wherein the vibration of the stimulator member has a frequency and amplitude and the stimulator member is so configured and arranged as to produce a sufficient vibrational effect on the salivary member that a significant increase in the salivary production into the oral cavity results.

### BRIEF DESCRIPTION OF THE DRAWINGS

FIGS. 1 and 2 are anatomical drawings showing the position of various salivary glands and/or salivary ducts in the facial structure.

FIG. 3 shows a simplified drawing of one embodiment of the present invention including a driver apparatus.

FIGS. 4-6 show other embodiments of the present invention.

### BEST MODE FOR CARRYING OUT THE INVENTION

The present invention operates by physical stimulation of the salivary glands and/or the salivary ducts, which lead from the salivary glands to the oral cavity region. Referring to FIG. 3 in general, the embodiment shown includes a driver member 10 and a stimulator member 12 which is mounted on a lever arm which is vibrated in a back and forth manner by driver member 10. The stimulator member 12 will be discussed in detail below.

In the particular embodiment shown, stimulator 12 is vibrated back and forth at a frequency within the range of 40 Hz-500 Hz, and in particular 261 Hz, with an amplitude within the range of 0.5 mm-6 mm. A mechanism for producing such a movement is shown and described in detail in U.S. Pat. Nos. 5,189,751 and 5,378,153, both of which are owned by the assignee of the present invention. While the embodiment shown does have certain specified ranges of frequency and amplitude, it should be understood that those ranges are not necessarily exclusive. Other frequencies and amplitudes may in fact achieve the same effects. This will be discussed in more detail below.

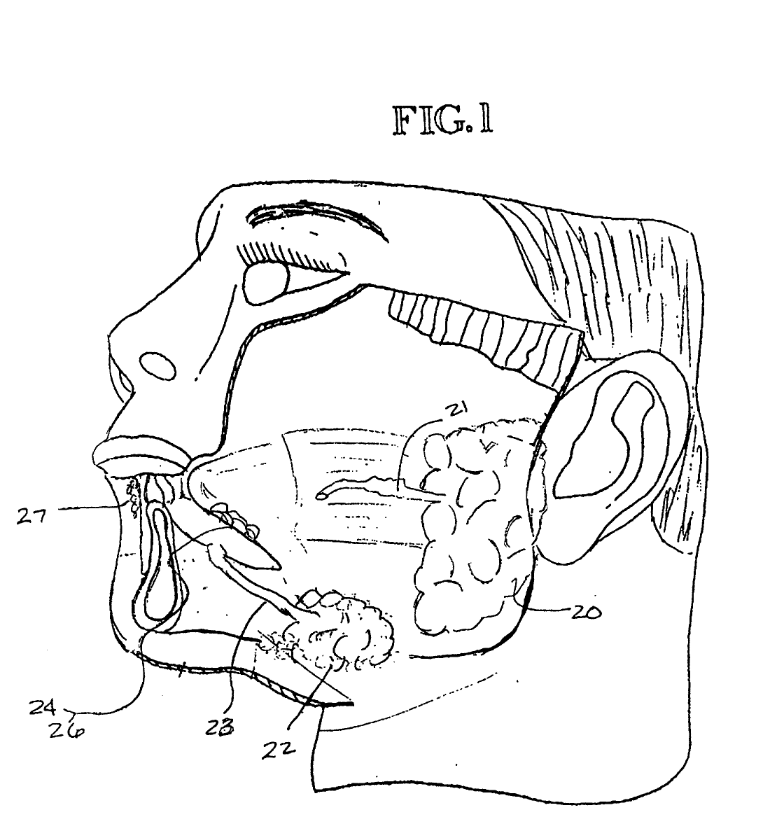

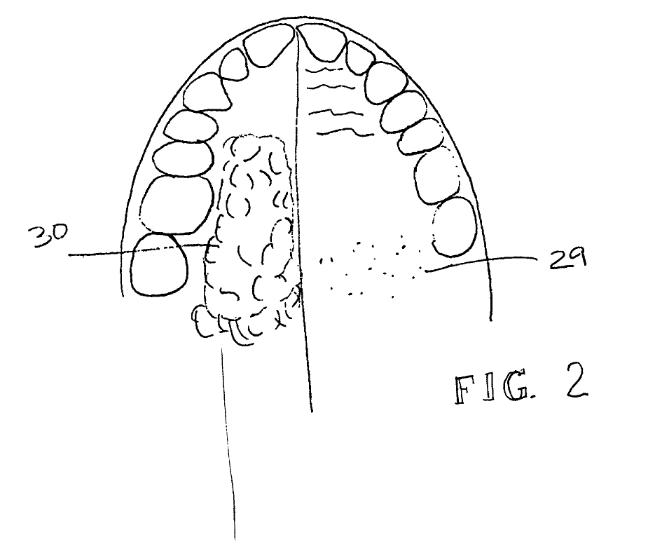

FIGS. 1 and 2 show generally the arrangement of the salivary glands and the salivary ducts in the facial structure. They include generally the parotid gland 20 and the submandibular gland 22, both of which are located in part exterior of the oral cavity adjacent the rear and lower edges of the mandible jaw bone, respectively. A parotid duct 21 extends from the parotid gland 20 into the oral cavity region, at a point above the maxillary upper teeth (molars). A submandibular duct 23 connects the submandibular gland 22 to the oral cavity in the vicinity of the front lower teeth. Likewise, in the lower portion of the mouth is a sublingual gland 24 and its associated ducts 26 and labial glands 27. In addition, there are many palatine glands 30 in the roof of the mouth which secrete saliva directly into the mouth. The palatine glands 30 are located at the hard and soft palate and the sublingual glands 24 are located in the interior portion of the mouth or floor.

There are also salivary glands located within the tongue as well as other areas of the mouth. It thus should be clear that there are several salivary glands within the facial structure, some of which are located exteriorly of the facial structure, others of which are located interiorly thereof, within the oral cavity region, and some that occupy both regions. In addition, some of the salivary glands, such as the parotid gland and the submandibular gland, incorporate relatively lengthy ducts which connect the glands to the intra-oral area. While xerostomia is generally regarded as a condition characterized by insufficiency of saliva produced by the salivary glands, it has been discovered that the lack of saliva in the mouth can be due to partially blocked/occluded salivary duct or ducts.

The apparatus and method of the present invention provides treatment for the xerostomia condition by physically stimulating the salivary gland so as to produce more saliva and/or stimulating the salivary duct so as to move saliva past any partial blockage or by helping to dislodge a “mucous plug” in the duct. One embodiment of a stimulator member for accomplishing the above is shown in FIG. 3 with driver 10. In that embodiment, the stimulator member shown generally at 12 is made from elastomeric material, such as rubber or thermoplastic material, having a durometer of approximately 22 Shore A. The durometer could be in the range of 20-60 Shore A.

Stimulator member 12 includes a base section 42 and a plurality of upstanding, substantially identical flexible fingers 44 extending therefrom. In the embodiment shown, base section 42 is 0.480 inches long and 0.258 inches wide and 0.067 inches thick. The fingers 44 have a diameter of approximately 0.097 inches (range of 0.06 inches-0.25 inches) and a height of approximately 0.254 inches (range of 0.2-0.5 inches). The tops of the fingers 44 are rounded. In the embodiment shown, the stimulator member includes two adjacent columns of four such fingers, with the fingers being evenly spaced and separated by a distance between their center points of approximately 0.119 inches in each column (adjacent) and approximately 0.134 inches between the two columns.

Alternatives to an elastomeric material for the stimulator member are possible; however, the selected material must be flexible and resilient and quite soft. The fingers 44 readily bend under load but come back to their original position quickly after the load is removed. Stimulator member 12 in the embodiment shown is positioned in a mounting block 46 which is secured to the end of the vibrating lever arm. Positioned beneath base portion 42 of the stimulator member 12 is a Styrofoam pad 48, the purpose of which is to reduce the mass of the stimulator assembly to a resonant frequency of 261 Hz. In the embodiment shown, pad 48 is approximately 0.067 inches thick. The resonant frequency of the stimulator assembly, including the stimulator member, the mounting block, and the pad, should be approximately the same as the frequency of vibration, i.e. the driving frequency of driver member 10. This increases the vibrating frequency (efficiency) of the apparatus.

In the embodiment shown, the driving frequency is approximately 8-10 Hz higher than the unloaded (running in air) resonant frequency of the stimulator assembly. The stimulator member is designed so as to cause the resonant frequency of the stimulator assembly to increase slightly, so as to be approximately equal to the driving frequency, when the stimulator member is brought into contact with tissue. This causes the amplitude of the stimulator member to increase under load and thus become somewhat more vigorous in vibrating the salivary glands/ducts or other tissues in contact with the salivary glands/ducts.

During operation of the apparatus, when the stimulator member 12 is loaded, by contacting (pressing) the stimulator member against tissue, the tips of fingers 44 tend to move in random directions. This increases the stimulation, i.e. vibration, or conduction of vibration of the tissue. The vibration of stimulator member 12, when pressed against the tissue surrounding the salivary glands or against the salivary glands, has been found to produce a significant increase in the output of the saliva from salivary glands. The actual degree of salivary increase will vary from individual to individual depending upon the particular cause and the physical condition of the gland and/or duct. It is the actual physical vibration of the glandular tissue which produces the desired increase in saliva. The apparatus of the present invention includes the vibration characteristics produced by the driver and the physical characteristics of the stimulator member, which in combination produce the desired results.

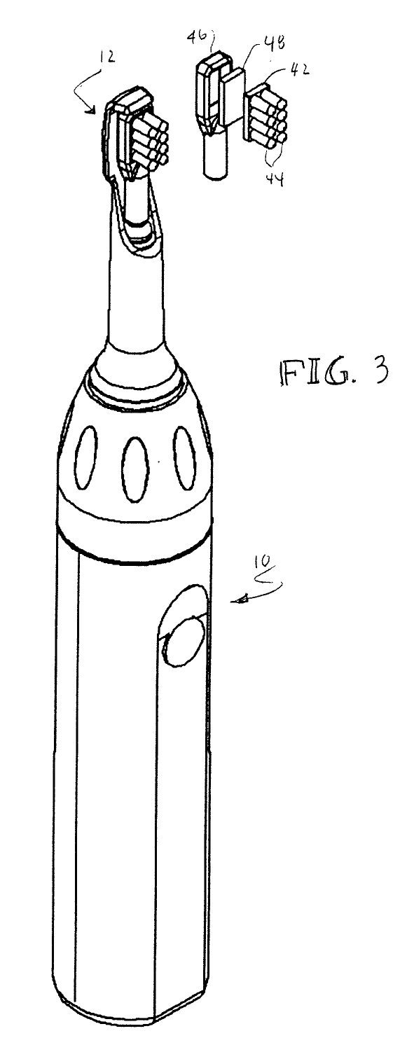

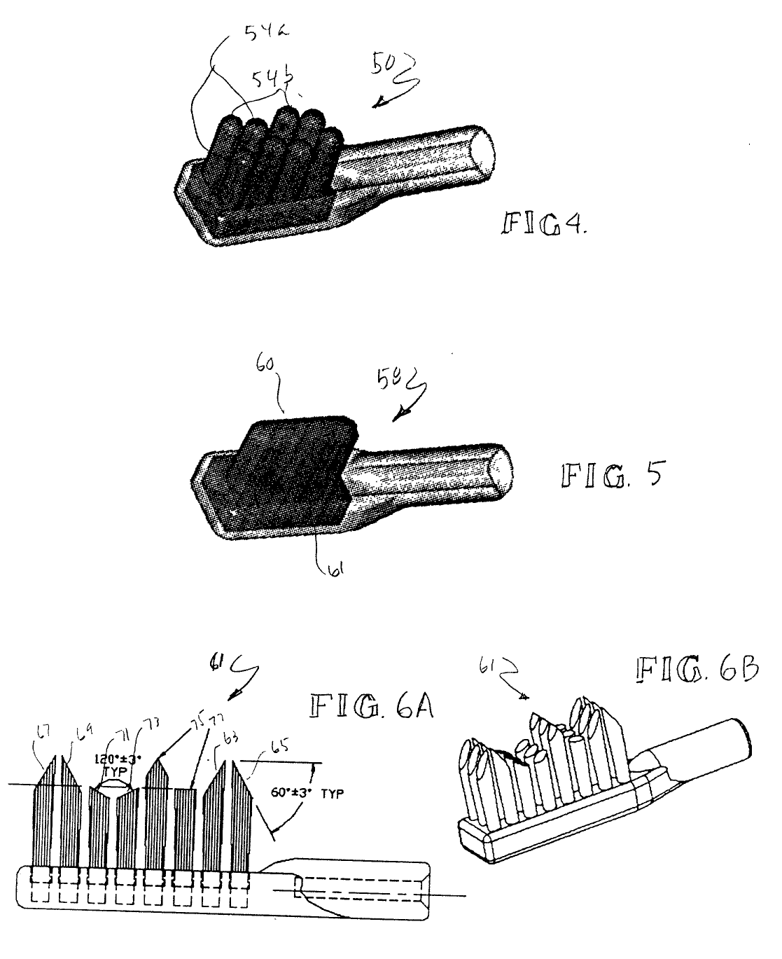

FIGS. 4-6 show some alternative configurations of the stimulator member. These embodiments are not intended to be exhaustive, but rather illustrative of additional possible stimulator configurations. FIG. 4 shows one alternative stimulator embodiment 50. In this embodiment, which is otherwise similar to the embodiment of FIG. 3, the stimulator fingers alternate between shorter and taller configurations in the two columns. The shorter fingers, for example finger 54a, have a height of 0.234 inches, while the taller fingers, for example 54b, have a height of 0.274 inches. These heights could of course differ to some extent. Stimulator member 50, which is generally preferred, has a greater stimulation effect than the embodiment of FIG. 3, resulting in the production of a greater amount of saliva in a given time relative to stimulator member 12. The individual fingers in the embodiments of FIGS. 3 and 4 could be random in orientation. The number of fingers could vary, within a range of 4-100.

FIG. 5 shows another embodiment in which a stimulator member 58 includes a single central finger 60, extending upwardly from a base 61. The single finger 60 in the embodiment shown is approximately 0.283 inches high, approximately 0.12 inches thick and 0.46 inches long. The ends of the finger are curved, as is the top thereof. These dimensions can be varied to some extent. This could include ranges in height of 0.2-0.5 inches, lengths of 0.2-1 inch, and thickness of 0.06-0.5 inches. This embodiment is also made from elastomeric material, with similar durometer values (in the range of 20-60 Shore A) as the previous embodiments.

FIGS. 6a and 6b show another embodiment 61 which is somewhat different from the previous embodiments, in that the stimulator “fingers” in this embodiment comprise tufts of nylon bristles instead of elastomeric ribs. This embodiment includes three columns of eight tufts each, with the tops of the individual tufts being configured as shown. The back two rows 63, 65 (each row comprising three tufts) and the front two rows 67, 69 are angled at approximately 60°±3° to a point between the two rows as shown, while the third and fourth rows 71, 73 angle downwardly toward each other at 30°±3° below the horizontal. The fifth row 75 has a pointed top, with a very slightly shorter height in the front and back columns. The sixth row 77 has a flat top.

The individual bristles comprising the tufts have a diameter of 0.003-0.005 inches in rows 3, 4, 6 and 0.005-0.007 in rows 1, 2, 5, 7, 8. The number of bristles in a tuft will range between 20-75. The lengths of the bristles are within the range of 0.200-0.500 inches. This results in an ultra-soft stimulator, so as not to injure the sensitive intraoral mucous membranes of patients with xerostomia. The embodiment of FIGS. 6a and 6b have the capability of providing a cleansing effect for the teeth, as well as providing stimulation to the salivary glands and salivary ducts.

Thus, the stimulator member may take various configurations and arrangements. Some stimulator apparatus have a relatively long reach, such as some of those shown herein, and may be used both inside and outside the oral cavity. Other stimulators may have a short reach and thus are suitable only for massaging skin tissue on the outside of the oral cavity. In addition, some of the stimulator members have a configuration which is more suitable for use outside the oral cavity. Other configurations may be useful both inside and outside the oral cavity. The stimulator member must, however, be able to physically vibrate the tissue against which it is positioned so as to produce a vibration within the salivary gland sufficient to significantly increase saliva production and/or a vibration of the salivary duct sufficient to move saliva through a salivary duct which may be partially occluded or collapsed.

Further, while a particular range of frequencies and amplitudes has been disclosed which in fact produces the desired effects, it should be understood that other frequencies and amplitudes may also produce the desired effects on the salivary glands and salivary ducts. What is important is that the stimulator member produces a physical, vibrating effect upon the tissue against which it is pressed and ultimately upon the salivary gland and/or the salivary duct adjacent to that tissue. Physical vibration action is thus in effect transmitted through the tissues contacted by the stimulator and ultimately into the salivary gland or duct (or in some cases the gland and duct directly). This requires a careful adjustment of the frequency and amplitude of the driving signal, as well as the characteristics of the stimulator member. The above embodiments produce the desired effects.

In the method of the present invention, the driver is typically turned on so that the stimulator member is vibrating at a sustained desired frequency and amplitude, prior to the application of the stimulator to the selected tissues. Typically, but not necessarily, the apparatus will thus be already vibrating when it is placed either against a selected salivary gland or tissues adjacent the gland. As discussed above, there are salivary glands located both inside and external of the facial structure. All of the embodiments disclosed herein can be used for the internal glands; however, the embodiment of FIG. 5 appears to have the greatest potential effect on the glands outside of the facial structure. only a relatively light contact (100-300 grams) between the vibrating stimulator and the gland, duct or adjacent tissue, is required for a time typically within a range of thirty seconds to two minutes. The time will vary, however, depending on the individual.

As indicated above, a standard acceptable unstimulated flow rate is 0.3 milliliters per minute of saliva. The expected increase in saliva production by use of the apparatus and method of the present invention is at least 0.1 milliliter for those who are initially below the 0.3 milliliter level. A 0.1 milliliter/minute increase in unstimulated flow rate is indicated to be substantial in saliva production. For those patients who have almost no saliva production, this increase will result in a substantial improvement in their subjective feelings of dry mouth as well as improvement in the objective symptoms, while those who produce reduced saliva, such as in the neighborhood of 0.15 or 2 milliliters per minute, will have their saliva production raised to almost normal levels, with significant reduction in symptoms. In some patients, however, it is understood that due to severe damage or disease, or surgical intervention, stimulation in accordance with the principles of the present invention will not produce the desired effect, due to physical incapability of the gland(s) to produce saliva.

Hence, an apparatus and method for stimulating the production of saliva has been disclosed. It results in the stimulation of the glands to increase salivary production as well as assisting in the movement of saliva through partially occluded or collapsed saliva ducts. In the claims which follow, the term “salivary member” is used to include both salivary glands and salivary ducts which extend from the glands.

Although preferred various embodiments have been disclosed for purposes of illustration, it should be understood that additional changes, modifications and variations of such embodiments may be made within the spirit of the present invention which is defined by the claims which follow.

What is claimed is:

1. An article for use in treatment of xerostomia, comprising:
a driver assembly capable of producing a vibrating action at a drive frequency;
a stimulator assembly operatively connected to said driver assembly such that the stimulator assembly vibrates in response to operation of the driver assembly, the stimulator assembly including a stimulator member for vibrating a salivary member, wherein the vibration of the stimulator member has a frequency and amplitude and the stimulator member is so configured and arranged as to produce a sufficient vibrational effect on the salivary member that a significant increase in the saliva production into the oral cavity results.

2. An apparatus of claim 1, wherein the stimulator assembly has a resonant frequency which is approximately the same as the drive frequency of the driver assembly.

3. An apparatus of claim 2, wherein the resonant frequency increases slightly when the apparatus in placed under load.

4. An apparatus of claim 2, wherein the drive frequency is within the range of 40 Hz to 500 Hz.

5. An apparatus of claim 1, wherein the driver assembly drives the stimulator member at a frequency which results in a random movement of tips of the stimulator member.

6. An apparatus of claim 1, when the stimulator member is made from an elastomeric material having a durometer in the range of 20-60 Shore A.

7. An apparatus of claim 1, wherein the stimulator member includes a base portion and a plurality of elongated fingers which extend upwardly therefrom.

8. An apparatus of claim 7, wherein the fingers are generally cylindrical, having a length within the range of 0.2-0.25 inches long and a diameter within the range of 0.06-0.25 inches.

9. An apparatus of claim 7, wherein the fingers are of equal length.

10. An apparatus of claim 7, wherein the fingers are of unequal length.

11. An apparatus of claim 1, wherein the stimulator member comprises a base portion and a single rib which extends upwardly therefrom, the single rib being having a height within the range of 0.2-0.5 inches, a length within the range of 0.2-1 inch, and a thickness within the range of 0.06-0.5 inches.

12. An apparatus of claim 1, wherein the stimulator assembly and the stimulator member have such a configuration as to be suitable only for tissue vibration outside of the oral cavity.

13. An apparatus of claim 1, wherein the salivary member is a salivary gland and vibration thereof results in a substantial increase in the production of saliva by the salivary gland.

14. An apparatus of claim 1, wherein the salivary member is a salivary duct and vibration thereof results in a substantial increase in flow of saliva through said salivary duct.

15. A method for treatment of xerostomia, comprising the steps of:
vibrating a stimulator assembly such that the tip of a stimulator member portion thereof moves at a selected drive frequency and amplitude; and
moving the vibrating stimulator into contact with a salivary member or tissue adjacent thereto, wherein the frequency and amplitude are such and the stimulator member is configured and arranged so as to physically vibrate the salivary member so as to produce a significant increase in saliva into the human mouth.

16. A method of claim 15, wherein the resonant frequency of the stimulator assembly is approximately the same as the drive frequency.

17. A method of claim 15, wherein the drive frequency is within a range of 40 Hz-500 Hz.

18. A method of claim 15, wherein the salivary member is a salivary gland and vibration thereof results in a substantial increase in the production of saliva.

19. A method of claim 15, wherein the salivary member is a salivary duct and vibration thereof results in a substantial increase in flow of saliva through said salivary duct.
